(19) United States
(12) Patent Application Publication
(10) Pub. No.: US 2023/0342970 A1
(43) Pub. Date: Oct. 26, 2023

(54) Method for geolocating an action of a user or of the avatar of a user in a respectively real or virtual environment

(71) Applicant: ORANGE, Issy-les-Moulineaux (FR)

(72) Inventors: Fabrice Boudin, Chatillon Cedex (FR); Arnaud Brun, Chatillon Cedex (FR)

(21) Appl. No.: 18/305,680

(22) Filed: Apr. 24, 2023

(30) Foreign Application Priority Data
Apr. 25, 2022 (FR) 2203797

(51) Int. Cl. G06T 7/70; G06T 17/00; G06V 10/25; G06V 40/20

(52) U.S. Cl. CPC G06T 7/70; G06T 17/00; G06V 10/25; G06V 40/20; G06V 2201/07

(57) ABSTRACT

A geolocation method including: detecting that a user or an avatar of a user is carrying out an action in its respectively real or virtual environment; determining geolocation data of an area of the environment in which the action was detected; and based on the geolocation data and data representative of the detected action: determining that the action corresponding to the geolocation data has already been implemented by a plurality of physical people or avatars in the area, and that the implementation of the action is predominant with respect to the implementation of at least one other action in the area; and identifying the area as an area of the environment dedicated to providing at least one element linked to the data representative of the detected action or as an area of the environment able to be configured on the basis of the data.

### FIELD OF THE DISCLOSURE

The disclosure relates to the geolocation of a user and to the use of geolocation data, in particular to offer content items and/or products and/or services linked to these data.

### PRIOR ART

Nowadays, various solutions allow in particular content providers or publishers, on commercial signage, to make content recommendations and to provide advertising spaces (in their applications and web applications) after having collected and then used certain personal user data. These personal data may for example provide indications about the profile (age, gender, profession, etc.), the lifestyles and the centres of interest of each of the users. Once collected, these data may possibly be anonymized or semi-anonymized in accordance with the regulations in force regarding personal data protection.

In particular, in what are known as “geolocated” solutions (that is to say also using the geolocation of the user), these personalized recommendations and these personalized advertisements (or other targeted content items) are determined by using personal data associated with contextual data, in particular the geolocation of the user. Geolocation makes it possible for example to determine that the user is located close to a particular location, a point of sale for example. Such contextual data on the geolocation of the user may be beneficial to use in order to offer this user for example a content item, a content recommendation or an advertisement that are linked to the place where the user is located and/or linked to the profile of said user. Although this geolocation technique makes it possible to improve the content recommendation, it is however limited to one user at a time, and for a given geographical area that is sometimes defined vaguely or the perimeter of which is far too large to hope to achieve reliable use of the geolocation data. Furthermore, this geolocation technique is implemented to offer a single type of service to the user who has been geolocated, which is that of content recommendation.

### SUMMARY

One aspect of the present application relates to a geolocation method comprising the following:
detecting that a user or an avatar of a user is carrying out an action in his respectively real or virtual environment,
determining geolocation data of an area of the real or virtual environment in which the action was detected,
based on the geolocation data and data representative of the detected action:
   determining that the action corresponding to the geolocation data has already been implemented by a plurality of physical people in the area of the real environment or by a plurality of avatars in the area of the virtual environment, and that the implementation of the action is predominant with respect to the implementation of at least one other action in the area of the real or virtual environment,
   identifying the area as an area of the real or virtual environment dedicated to the provision of at least one element linked to the data representative of the detected action or as an area of the real or virtual environment able to be configured on the basis of the data.

The geolocation method according to an exemplary embodiment of the present disclosure advantageously makes it possible to locate an area of a real, respectively virtual, environment in which a user, respectively an avatar of a user, carries out an action, so as to precisely identify whether the located area of the real or virtual environment is considered to be suitable for offering one or more elements linked to the action that has been detected as predominant in this area or for being modified/configured in a certain way on the basis of the action that has been detected in this area. An action is predominant with respect to another action if it is implemented more frequently or is assigned a weight greater than that of another action, etc.

Virtual environment is the name given to an environment that is simulated digitally using a virtual reality device, in which one or more avatars are able to move and interact with this environment.

Thus, by virtue of the geolocation method according to an exemplary embodiment of the present disclosure, the identification of the area as an area dedicated to the provision of at least one element linked to the data representative of the detected action or as an area able to be configured on the basis of said data will be effective only if such an action has been implemented predominantly with respect to other actions implemented in this area by a certain number of individuals or avatars, depending on whether the action has been detected in the real or virtual environment, respectively.

According to one particular embodiment,
the action carried out in the real environment comprises an interaction of the user with an interface present in the real environment or an activity of the user that has been detected autonomously by an activity detection appliance,
the action carried out in the virtual environment comprises an interaction of the avatar of a user with an object or another avatar in the virtual environment.

By virtue of this embodiment, the geolocation method makes it possible to geolocate various possible actions, an interaction or an activity of the user in the real environment, an interaction of the avatar of the user with an object or another avatar in the virtual environment, such that the data representative of these actions are as varied as possible and thus enrich the data processing to be implemented by a processing device.

According to another particular embodiment, the element provided in the identified area is a multimedia content item.

Such an embodiment advantageously makes it possible to recommend or to offer one or more multimedia content items precisely in the area of the real or virtual environment that has been identified using the geolocation method, these one or more content items being relevant with respect to the action detected in this area. By virtue of an exemplary embodiment of the present disclosure, the multimedia content item recommended or offered in the identified area is not only linked to the nature of the action that has been implemented, but it is also made available in the area precisely where this action has been detected. This results in a content recommendation that is particularly well targeted and that is furthermore adapted both to a real environment and to a virtual environment in which a physical person or an avatar of a physical person, respectively, is moving.

Such a multimedia content item may for example be transmitted, via a communication network, in the form of an Internet link, a notification, etc., to a terminal of a user who is moving in the area of the real environment that has been identified, respectively to a terminal rendering a virtual environment in an area of which an avatar of a user is moving. Such a multimedia content item is for example jazz music, if the action that has been detected in this area comprised for example a Web search for a jazz music composer. Thus, by virtue of this embodiment, it is possible to adapt the multimedia content recommendation so as to limit the work for the communication network that is brought about by the untimely transmission of multiple multimedia content items to users, by transmitting only content items the relevance of which has been statistically verified. It is also possible to anticipate the needs of a user by providing him for example with information that he might require afterwards in the area of the real environment in which he is located (for example the location of toilets in a shopping centre, the location of a Wi-Fi hotspot in a railway station, etc.) and for which it has been statistically determined that this information has been searched for a very large number of times before by users who were in this area. An exemplary embodiment of the present disclosure thus makes it possible to optimize the content recommendation as implemented in current content recommendation systems.

According to another example, such a multimedia content item may be broadcast in the identified area of the real environment, for example in the form of an audio message, an image or a video. If for example it has been determined that, in the identified area of the real environment, the action relating to the online purchase of sporting goods is predominant:
an audio advertising message will be broadcast by one or more loudspeakers in said identified area, said message acoustically rendering information about for example a sports brand located or not located in this area,
an advertising image promoting a brand of sports items or a sports hall will be displayed on an advertising sign in the identified area,
etc.

According to another particular embodiment, if the area of the real or virtual environment is identified as a configurable area, the area is modified so as to provide a product or a service, linked to the detected action, to a user who is located in the identified area of the real environment or to an avatar of a user that is located in the identified area of the virtual environment.

Such an embodiment advantageously makes it possible to rearrange the area of the real or virtual environment that has been identified using the geolocation method in another way, such that this area is able to offer products and services relevant with respect to the predominant action detected in this area. By virtue of an exemplary embodiment of the present disclosure, the one or more products/services offered in the area identified by the processing device is/are not only linked to the nature of the action that has been implemented, but it/they is/are also made available in the area precisely where this predominant action has been detected. Thus, for example:
an area identified in the real environment might be rearranged so as to incorporate for example a sports trail, if the action that has been detected as predominant in this area was a running activity,
an area identified in the virtual environment might be digitally remodelled so as to incorporate for example a shoe shop, if the action that has been detected as predominant in this area was the online purchase of shoes by user avatars.

According to another particular embodiment, for a given user, at a given time, the geolocation method is implemented simultaneously in the real environment where the user is moving and/or in at least one virtual environment where an avatar of the user is moving.

Such an embodiment makes it possible, at a given time, to detect all possible actions that a user or his avatar implements at this given time. Thus, for this user who, at this given time, is active in an area of the real environment and who, in parallel, is present in an area of a virtual environment (for example: video game, virtual visit to a flat, etc.), it is possible to process:
not only first geolocation data of the area of the real environment in which the user is moving, and also first data representative of the action that the user has carried out in this area,
but also second geolocation data of the area of the virtual environment in which the avatar of the user is moving, and also second data representative of the action that this avatar has carried out in this area of the virtual environment.

Such an embodiment thus advantageously makes it possible, at a given time, to pool the geolocation of a user in an area of the real environment and of at least one avatar of this user in an area of the virtual environment, thereby making it possible to supply a data processing device with multiple geolocation data with a view to far more complete use of these data, in order to optimize the tagging of the geolocated areas as areas dedicated to the provision of at least one element linked to the data representative of the detected action or as an area able to be configured on the basis of said data.

Of course, the geolocation method may be implemented only when the user is moving in the real environment or only when one or more avatars of the user are moving in respectively one or more virtual environments.

According to another particular embodiment, the geolocation data of the area of said at least one virtual environment that are determined when implementing the geolocation method are associated with an activity indicator of the avatar of the user in this area, said indicator being set to a first value representative of an absence of activity of the avatar or to a second value representative of actual activity of the avatar.

Such an embodiment makes it possible to optimize the data processing in order to take into account only data representative of actual activity of the avatar, for the purpose of optimizing the identification of the area as an area dedicated to the provision of at least one element linked to the data representative of the detected action or as an area able to be configured on the basis of said data.

According to another particular embodiment, the geolocation data of the area comprise:
the two-dimensional, respectively three-dimensional, coordinates of a point of the area, and
the radius of a circle, respectively of a sphere, centred on the point.

Such an embodiment has the advantage of providing geolocation data in a highly simple format, thereby reducing the transmission cost of these data if they are transmitted to a processing device.

According to another particular embodiment, the data representative of the detected action comprise at least one identifier representative of the type of action.

Such an embodiment has the advantage of informing the processing device what type of action was carried out at a given time for a given user or avatar, in a particular area of the real or virtual environment, with a view to being statistically used in a reliable manner and with sufficiently fine granularity by the processing device. Thus, for example, if the action is an interaction of the user with his terminal, for example a search using keywords, the selection of an Internet link, an online purchase, these three actions will be respectively associated with three distinct identifiers uniquely characterizing the action performed.

According to another example, if an avatar performs gardening in its virtual environment, this specific action will be associated with an identifier distinct from the abovementioned three identifiers.

According to another particular embodiment, the identifier representative of the type of action is associated with at least one indicator of an object targeted by the action. Such an embodiment advantageously makes it possible to supplement the data representative of the action with an indicator representative of the object that is targeted by the action, thereby making it possible to even further enrich the data processing. Such an object may be for example:
a product purchased on the Web by the user in the area of his real environment or by the avatar of a user in the area of its virtual environment: the indicator of this product will then be for example the name of this product;
a keyword searched for on the Web by the user in the area of his real environment or by the avatar of a user in the area of its virtual environment: the indicator of the object will then be for example the title of this keyword;
a multimedia content item streamed on the terminal of the user in the area of his real environment or on a terminal rendering a virtual environment in an area of which an avatar of a user is moving: the indicator of the object will then be for example a title or the author of this multimedia content item or, more generally, any metadatum associated with this multimedia content item;
a topic or a field associated with the action implemented in the real or virtual environment: the indicator of the object will then be for example a word associated with this topic or with this field. If for example the action detected in an area of the real environment is running, the indicator will be for example the word “running”. If for example, in an area of the virtual environment, the avatar of the user is playing the role of a classical music orchestral conductor, the indicator of the object will be for example the term “classical music”,
etc.

According to another particular embodiment, the identifier representative of the type of action is associated with a weighting value of the action.

Such an embodiment advantageously makes it possible to assign a particular weighting value to a type of action, this assignment being dependent on the context of the data processing to be implemented by the processing device.

Thus, for example, if the processed data are used for the purpose of rearranging a shopping area, if the actions detected in this area are an online purchase of a product and a simple Web search for this product, the type of action “purchase” will have a higher weighting value than that assigned to the type of action “search”.

The various abovementioned embodiments or implementation features may be added, independently or in combination with one another, to the geolocation method, as defined above.

The disclosure also relates to a geolocation device comprising a processor that is configured to implement the following:
detecting that a user or an avatar of a user is carrying out an action in his respectively real or virtual environment,
determining geolocation data of an area of the real or virtual environment in which the action was detected,
transmitting said geolocation data and data representative of the detected action to a data processing device.

The disclosure also relates to a device for processing geolocation data, comprising a processor that is configured to implement the following:
receiving, from a geolocation device, geolocation data of an area of a real or virtual environment in which an action carried out by a user or an avatar of a user, in his real or its virtual environment, respectively, has been detected, and data representative of the detected action,
when it has been determined that the action corresponding to the received data has already been implemented by a plurality of physical people in the area of the real environment, respectively by a plurality of avatars in the area of the virtual environment, and that the implementation of the action is predominant with respect to the implementation of at least one other action in the area, identifying the area as an area dedicated to the provision of at least one element linked to the data representative of the detected action or as an area able to be configured on the basis of the data.

An exemplary embodiment of the present disclosure also relates to a geolocation system comprising:
the abovementioned geolocation device according to an exemplary embodiment,
the abovementioned device for processing geolocation data according to an exemplary embodiment.

The disclosure also relates to a computer program comprising instructions for implementing the geolocation method, according to any one of the particular embodiments described above, when said program is executed by a processor. Such instructions may be stored durably on a non-transient memory medium of the geolocation system implementing the geolocation method according to an exemplary embodiment of the present disclosure.

This program may use any programming language and be in the form of source code, object code or intermediate code between source code and object code, such as in a partially compiled form, or in any other desirable form.

The disclosure also targets a computer-readable recording medium or information medium containing instructions of a computer program as mentioned above. The recording medium may be any entity or device capable of storing the program. For example, the medium may comprise a storage means, such as a ROM, for example a CD ROM or a microelectronic circuit ROM, or else a magnetic recording means, for example a mobile medium, a hard disk or an SSD.

On the other hand, the recording medium may be a transmissible medium such as an electrical or optical signal, which may be routed via an electrical or optical cable, by radio or by other means, such that the computer program that it contains is able to be executed remotely. The program according to an exemplary embodiment of the present disclosure may in particular be downloaded from a network, for example an Internet network.

As an alternative, the recording medium may be an integrated circuit in which the program is incorporated, the circuit being designed to execute or to be used in the execution of the abovementioned geolocation method.

According to one exemplary embodiment, the present technique is implemented by way of software components and/or hardware components. With this in mind, the term “device” may correspond in this document equally to a software component, to a hardware component or to a set of software components and hardware components.

### BRIEF DESCRIPTION OF THE DRAWINGS

Other features and advantages will become apparent on reading particular embodiments of the disclosure, which are given by way of illustrative and non-limiting example, and the appended drawings, in which:

FIG. 1A shows a geolocation system according to a first embodiment of the disclosure,

FIG. 1B shows a geolocation system according to a second embodiment of the disclosure,

FIG. 1C shows a geolocation system according to a third embodiment of the disclosure,

FIG. 2A shows a geolocation device, according to one particular embodiment of the disclosure,

FIG. 2B shows a geolocation device, according to one particular embodiment of the disclosure,

FIG. 3 shows a device for processing geolocation data, according to one particular embodiment of the disclosure,

FIG. 4A shows the main actions implemented in the geolocation method according to a first particular embodiment of the disclosure,

FIG. 4B shows the main actions implemented in the geolocation method according to a second particular embodiment of the disclosure,

FIG. 4C shows the main actions implemented in the geolocation method according to a third particular embodiment of the disclosure,

FIG. 5 shows various actions implemented in the geolocation method according to one particular embodiment of the disclosure.

### DETAILED DESCRIPTION OF ONE OR MORE EMBODIMENTS OF THE DISCLOSURE

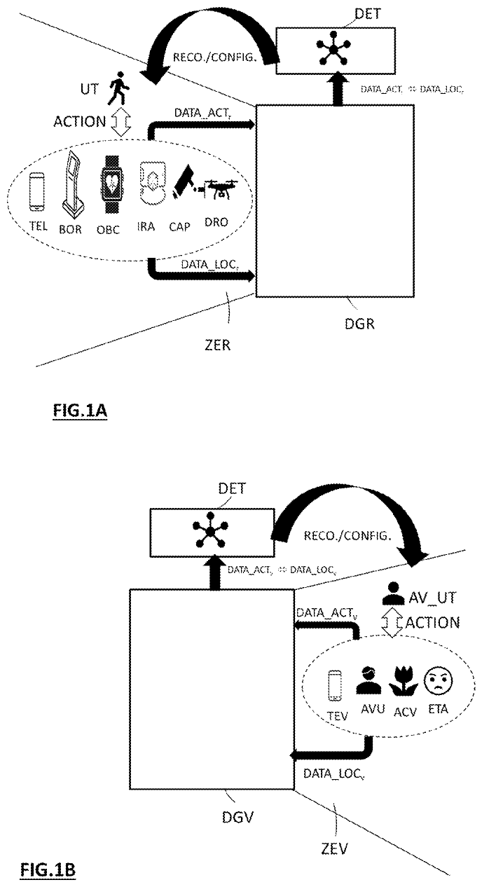

FIG. 1A shows a geolocation system for geolocating a user UT according to a first embodiment of the disclosure. In this first embodiment, the user UT is geolocated only in a real environment in which the user UT is moving, for example a street, a park, a shop, etc., and more precisely in an area ZER of this real environment. To this end, such a geolocation system comprises a geolocation device DGR for geolocating the user UT, which is configured to:
detect an action/activity carried out by the user UT in the area ZER,
determine the location of the user UT in the area ZER at the time when he performs the action/activity,
generate a dataset EDR that comprises activity data DATA_ACTᵣ representative of the action/activity carried out and data DATA_LOCᵣ representative of the location of the area ZER in which the user UT carried out the action/activity.

By way of non-exhaustive example, the type of actions/activities detected in the area ZER comprises:
an interaction of the user UT with a smartphone terminal TEL, in order for example to purchase a product online, listen to music stored on the terminal TEL or in streaming mode, search for a commodity, a product or a service via an Internet browser of the terminal TEL, etc.;
an interaction of the user UT with a multimedia terminal BOR installed in the area ZER, in order for example to search for an itinerary, find a particular place if the area ZER is for example a location in a town;
a particular action or activity of the user UT in the area ZER, said action or activity being detected transparently for the user UT by way of a connected object OBC (for example: connected watch) worn by said user and possibly being for example a sporting activity (for example: running), a stressful activity (for example: watching a horror film, waiting for a train, etc.) or a relaxing activity (for example: nap in a park, massage, etc.), a rest activity such as the user sleeping for example, a particular emotional state of the user (for example: stress level, emotion, mood, etc.);
an interaction of the user UT with an augmented-reality interface IRA, for example an augmented-reality application on the terminal TEL or on a tablet (not shown) that allows the user UT to see a product at home, for example in a corner ZER of his living room, without moving, before purchasing it, or else a hologram that is displayed in front of the user UT on the platform ZER of a railway station and with which the user UT interacts in order to ascertain train times, etc.;
a particular action/activity of the user UT detected by a sensor CAP placed in the area ZER, for example a microphone, a camera, a presence detector, etc. that detects for example that the user UT is singing, is sitting on a bench, is calling for help, etc.
a particular action/activity of the user UT detected by a drone DRO flying over the area ZER, for example the withdrawal of money from a cashpoint, the user entering a shop, etc.
etc.

The geolocation device DGR is furthermore configured to locate the area ZER in which the user UT carries out an action/activity. In one exemplary embodiment, the geolocation of said area ZER is associated with data comprising:
the two-dimensional (x,y), respectively three-dimensional (x,y,z), coordinates of a point of said area ZER, and
the radius of a circle, respectively of a sphere, centred on said point.

The geolocation may be determined directly by the geolocation device DGR if for example it is located physically in the area ZER or be obtained from the smartphone TEL, from the multimedia terminal BOR, from the connected object OBC, from the augmented-reality interface IRA, from the sensor CAP, from the drone DRO, etc., if the geolocation device DGR is located at a distance from the area ZER. In the latter case, the geolocation information is transmitted to the geolocation device DGR.

In one preferred embodiment, the geolocation data DATA_LOCᵣ comprise:
a point of the area ZER, which may be for example a point representative of a position, in the area ZER, of the smartphone TEL, of the multimedia terminal BOR, of the connected object OBC, of the augmented-reality interface IRA, of the sensor CAP, of the drone DRO, etc., and/or
a point representative of a position of the user UT at the time when said user carries out the action/activity in the area ZER, and/or
a point representative of a position of the geolocation device DGR itself, if it is located physically in the area ZER, etc.

The geolocation device DGR then processes the action/activity data DATA_ACTᵣ and the geolocation data DATA_LOCᵣ so as to generate a dataset EDR that comprises, in a dedicated particular format, an association of the data DATA_ACTᵣ with the data DATA_LOCᵣ.

According to one preferred embodiment, if the geolocation device DGR is located in the area ZER, the geolocation data generated by this device are for example as follows:
the coordinates (xᵣ₀, yᵣ₀) of the device DGR in the area ZER, for example latitude 48.8396952, longitude 2.2399123;
the radius of a circle centred on the coordinates (xᵣ₀, yᵣ₀) of the device DGR, for example 50 metres;
one or more identifiers of the most predominant/frequent actions or activities already carried out by various users in the area ZER, these actions having been determined/learned by a device DET for processing geolocation data that supplements the geolocation system according to an exemplary embodiment of the disclosure.

Such a device DET for processing geolocation data, which will be described further below in the description, is configured to identify, based on the data DATA_ACTᵣ and DATA_LOCᵣ, whether the area ZER is considered to be an area dedicated to the provision of at least one element linked to the data DATA_ACTᵣ or to be an area able to be configured on the basis of said data DATA_ACTᵣ.

In the sense of an exemplary embodiment of the disclosure, an element comprises for example a particular information item, a multimedia content item, an advertising message in text, audio and/or video form, an augmented-reality content item, for example a hologram, etc. Such elements may be provided in the area ZER by way of for example a content broadcast server for broadcasting content items via a communication network, an advertising department, etc. If it is for example an advertising message, it may be displayed on a sign installed in the area ZER or otherwise broadcast by a loudspeaker installed in the area ZER, etc.

The area ZER is said to be able to be configured on the basis of the data DATA_ACTᵣ in the sense that it is able to be modified or rearranged differently so as to take account of the data DATA_ACTᵣ. Thus, for example, if the data DATA_ACTᵣ relate to the online purchase of a product, for example a pair of shoes, via the terminal TEL, in the area ZER, and the processing device DET has determined that this purchase action has been implemented frequently or predominantly in the area ZER by a large number of users, the area ZER will be rearranged so as to be able to install a shoe shop there or simply supplemented in order to integrate for example an advertising sign promoting a shoe brand there. According to another example, if the data DATA_ACTᵣ relate to a running activity in the area ZER, which is detected by the connected object OBC worn by the user UT, and the processing device DET has determined that this particular activity has been implemented frequently or predominantly in the area ZER by a large number of users, the area ZER will be rearranged so as to be able to incorporate a sports trail there. According to yet another example, if the data DATA_ACTᵣ relate to an itinerary search in the area ZER, via the terminal BOR, and the processing device DET has determined that this particular search action has been implemented frequently or predominantly in the area ZER by a large number of users, the area ZER will be rearranged so as to be able to incorporate for example an augmented-reality interface there, such as for example a communicating information wall with which a user will be able to interact in order to look for his route.

FIG. 1B shows a geolocation system according to a second embodiment of the disclosure. In this second embodiment, the geolocation is implemented only in a virtual environment in which an avatar AV_UT of a user is moving, for example a video game, a digitally modelled enclosed location (for example: theatre, building, etc.) or a digitally modelled open location (stadium, park, forest, etc.), and more precisely, in an area ZEV of this virtual environment.

To this end, such a geolocation system comprises a geolocation device DGV for geolocating said avatar AV_UT, which is configured to:
detect an action/activity carried out by the avatar AV_UT in the area ZEV,
determine the location of the avatar AV_UT in the area ZEV at the time when it performs the action/activity,
generate a dataset EDV that comprises action/activity data DATA_ACTᵥ representative of the action/activity carried out by the avatar AV_UT in the area ZEV and data DATA_LOCᵥ representative of the location of the area ZEV in which the avatar AV_UT carried out the action/activity.

By way of non-exhaustive example, the type of actions/activities detected in the area ZEV comprises:
an interaction of the avatar AV_UT with a virtual interface of a virtual smartphone TEV in order for example to search for a content item using one or more keywords, watch a film, purchase a product online, listen to music in streaming mode, etc.,
an interaction of the avatar AV_UT with another avatar AVU present in the area ZEV, said interaction being able to be implemented as part for example of a fighting game, a game of hide and seek involving the avatars AV_UT and AVU, etc.,
an interaction of the avatar AV_UT with an object ACV present in the area ZEV, for example flowers in a garden if the avatar AV_UT is a gardener,
an emotional state, for example a stress level, a mood or a particular emotion, etc., which is or are assigned beforehand by a user to his avatar AV_UT, in the form for example of an icon representative of this stress level, this emotion or this mood, or of a modification of the avatar AV_UT representing it in accordance with the emotional state that has been assigned thereto (for example: in the case of a happy mood, the avatar smiles, in the case of stress, the avatar quivers, etc.), this emotional state not necessarily being the same as that felt by the user UT;
etc.

The avatar AV_UT may be the avatar of the user UT if said user has at least one avatar in a virtual environment, or be the avatar of a user different from the user UT. The avatar AV_UT may be the avatar of a user other than the user UT if said user does not have at least one avatar in a virtual environment.

The geolocation device DGV is furthermore configured to locate the area ZEV in which the avatar AV_UT carries out an action/activity.

The geolocation device DGV may be arranged in an appliance or a terminal that renders the virtual environment, for example a computer, a virtual-reality headset, a smartphone, etc., or be connected to this appliance or terminal by any appropriate communication means.

In one exemplary embodiment, the geolocation of said area ZEV is associated with data DATA_LOCᵥ comprising:
the two-dimensional (x,y), respectively three-dimensional (x,y,z), digital coordinates of a point of said area ZEV in a digital coordinate system modelled for the virtual environment, and
the radius of a circle, respectively of a sphere, centred on said point.

In one preferred embodiment, the geolocation data DATA_LOCᵥ comprise for example:
a point representative of a position, in the area ZEV, of the avatar AV_UT when it implements its action/activity, and/or
a point representative of a position of the other avatar AVU in the area ZEV, of the flower picked by the avatar AV_UT playing the role of a gardener, etc., and/or
a point of the area ZEV, which may be for example a point representative of a position, in the area ZEV, of the virtual smartphone TEV, of the object ACV with which the avatar AV_UT interacts, etc., and/or
a point representative of a digital position assigned beforehand to the geolocation device DGV itself,
etc.

The geolocation device DGV then processes the action/activity data DATA_ACTᵥ and the geolocation data DATA_LOCᵥ so as to generate a dataset EDV that comprises, in a dedicated particular format, an association of the data DATA_ACTᵥ with the data DATA_LOCᵥ.

In the same way as the first embodiment, the data DATA_ACTᵥ comprise one or more identifiers of the most predominant/frequent actions or activities already carried out by various user avatars in the area ZEV, these actions having been determined/learned by the abovementioned device DET for processing geolocation data, which supplements the geolocation system according to an exemplary embodiment of the disclosure.

In this second embodiment, the device DET for processing geolocation data is configured to process both the dataset EDR and the dataset EDV. It will be understood that, in other embodiments, one data processing device could be dedicated to processing the dataset EDR and another data processing device could be dedicated to processing the dataset EDV.

The abovementioned data processing device DET is configured, in this second embodiment, to identify, based on the data DATA_ACTᵥ and DATA_LOCᵥ, whether the area ZEV is considered to be an area dedicated to the provision of at least one element linked to the data DATA_ACTᵥ or to be an area able to be configured on the basis of said data DATA_ACTᵥ.

In the sense of an exemplary embodiment of the disclosure, an element of a virtual environment comprises for example a particular information item, a multimedia content item, an advertising message in text, audio and/or video form, a virtual-reality object, etc.

The area ZEV is said to be able to be configured on the basis of the data DATA_ACTᵥ in the sense that it is able to be modified or rearranged differently using appropriate software so as to take account of the data DATA_ACTᵥ in order to graphically modify the area ZEV. Thus, for example, if the data DATA_ACTᵥ relate to the online purchase of a product, for example a book, via the virtual terminal TEV, in the area ZEV, and the processing device DET has determined that this particular purchase action has been implemented frequently or predominantly in the area ZEV by a large number of user avatars, the area ZEV will be digitally/graphically reconfigured so as to be able to incorporate a library or a virtual media library. According to another example, if the data DATA_ACTᵥ relate to a glum mood of the avatar AV_UT in the area ZEV and the processing device DET has determined that this type of mood has been felt frequently or predominantly in the area ZEV by a large number of user avatars, for example a link to an easy-listening music server will be transmitted in inlaid mode in the area ZEV.

FIG. 1C shows a geolocation system according to a third embodiment of the disclosure. In this third embodiment, the geolocation is implemented both in a real environment of the type mentioned above and in a virtual environment of the type mentioned above. Such a geolocation system is particularly suitable for a user UT who is both active in the real environment and whose one or more avatars are active in one or more virtual environments, respectively.

This third embodiment uses elements in common with those of FIGS. 1A and 1B. For this reason, these elements are denoted using the same references and are not described again.

In the three embodiments that have been shown above, the processing device DET is separate from the geolocation device DGR or DGV. Of course, according to another embodiment, the data processing device DET and the geolocation device DGR or DGV may form a single entity.

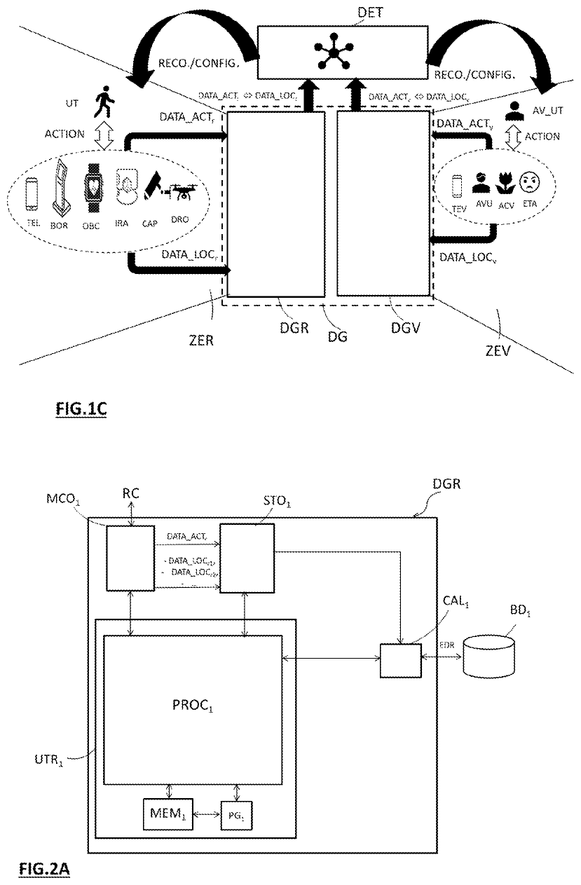

A description will now be given, with reference to FIG. 2A, of the simplified structure of a geolocation device DGR used in the geolocation system according to an exemplary embodiment of the disclosure.

Such a geolocation device DGR comprises:
a communication interface MCO₁ configured to communicate, via an appropriate communication network RC₁, with the processing device DET and action/activity detection devices, such as the smartphone TEL, the multimedia terminal BOR, the connected object OBC, the virtual-reality interface IRA, the sensor CAP, the drone DRO, shown in FIGS. 1A and 1C,
a memory STO₁ storing:
   initially the geolocation data DATA_LOCᵣ₀ of the geolocation device DGR, if this is installed in the area ZER, and potentially other additional geolocation data DATA_LOCᵣ₁, DATA_LOCᵣ₂, etc. received from the action/activity detection devices, such as the smartphone TEL, the multimedia terminal BOR, the connected object OBC, the virtual-reality interface IRA, the sensor CAP, the drone DRO, shown in FIGS. 1A and 1C, if such devices are configured to implement geolocation of the user UT, and
   the data DATA_ACTᵣ of the abovementioned type, which are received from the action/activity detection devices, such as the smartphone TEL, the multimedia terminal BOR, the connected object OBC, the virtual-reality interface IRA, the sensor CAP, the drone DRO, shown in FIGS. 1A and 1C.

The geolocation device DGR furthermore comprises a computing device CAL₁ configured to format the data DATA_LOCᵣ₀, DATA_LOCᵣ₁, DATA_LOCᵣ₂, . . . and DATA_ACTᵣ in the form of a data association that takes the form for example of the following table TAB₁ for a given user UT:

| | | | | Location of | |
|---|---|---|---|---|---|
| | | | | the user UT in | |
| | | Type of | Parameter(s) | the area ZER at | |
| Number of | Timestamp of | action/ | associated with | the time when the | Activity |
| the action/ | the action/ | activity | the action/ | action/activity | indicator |
| activity | activity | (Id₁) | activity | is carried out | (Ia₁) |
| 1 | 14/01/2022 | 00001 | A254H256ZJ | (X1ᵣ, Y1ᵣ, Z1ᵣ) | 1 |
| | 17:04:53 | | | | |
| 2 | 14/01/2022 | 00002 | 65GJ1H365P | (X2ᵣ, Y2ᵣ, Z2ᵣ) | 1 |
| | 17:05:07 | | | | |
| 3 | 14/01/2022 | 00001 | 9865H6E89 | (X3ᵣ, Y3ᵣ, Z3ᵣ) | 1 |
| | 18:24:32 | | | | |
| 4 | 14/01/2022 | 00005 | 985L6L5PS0 | (X4ᵣ, Y4ᵣ, Z4ᵣ) | 1 |
| | 18:29:12 | | | | |
| 5 | . . . | . . . | . . . | . . . | . . . |

In one particular embodiment, the table TAB₁ comprises six columns, namely:
the first column, entitled “Number of the action/activity”, indicates a chronological order number assigned to each action/activity implemented by the user UT over time, in a particular area ZER of the real environment,
the second column, entitled “Timestamp of the action/activity”, indicates the date and the time at which a particular action/activity of the user UT was detected,
the third column, entitled “Type of action/activity (Id₁)”, indicates the type of action/activity implemented by the user UT,
the fourth column, entitled “Parameter(s) associated with the action/activity”, provides information about at least one indicator or one parameter linked to the action/activity implemented by the user UT,
the fifth column, entitled “Location of the user UT in the area ZER at the time when the action/activity is carried out”, provides information about the coordinates, for example three-dimensional coordinates, contained in the data DATA_LOCᵣ,
the sixth column, entitled “Activity indicator (la₁)”, which is optional, provides information about the activity state or absence of activity of the user UT at the time of the detection. In the real environment, this indicator is for example set to 1 by default to indicate that the user UT is always active, even if he is sleeping or even if he is resting.

The type of action/activity “Id₁” uniquely characterizes a particular action or activity. By way of non-exhaustive example:

the identifier Id₁=00001 corresponds to consulting a content item, for example listening to a song, watching a film, etc.
the identifier Id₁=00002 corresponds to the online purchase of a product, for example shoes, a book, an application, etc.,
the identifier Id₁=00003 corresponds to a search using one or more keywords using a communication terminal, etc.,
the identifier Id₁=00004 corresponds to the activation of an Internet link,
the identifier Id₁=00005 corresponds to a reference for an activity implemented by the user UT, such as for example sport, singing, withdrawing money from a cashpoint, etc., sport here having for example the reference 985L6L5PS0.
etc.

The identifier Id₁=00001 is associated with at least one parameter or one indicator representative of the object of the action/activity implemented, for example a reference A254H256ZJ or 9865H6E89 of the consulted content item. The identifier Id₁=00001 may also be associated with a second parameter, such as for example a metadatum characterizing the consulted content item.

The identifier Id₁=00002 is associated with at least one or one indicator representative of the object of the action/activity implemented, for example a reference 65GJ1 H365P of the purchased product. The identifier Id₁=00002 may also be associated with one or more other parameters, such as for example keywords characterizing the purchased product, its place of manufacture, the brand of this product, etc.

The identifier Id₁=00003 is associated with at least one parameter or one indicator representative of the object of the action/activity implemented, for example the reference of the website placed first at the end of the search. The identifier Id₁=00003 may also be associated with one or more other parameters, such as for example the keywords of the search, the reference of the Web pages consulted at the end of the search, etc.

The identifier Id₁=00004 is associated with at least one parameter or one indicator representative of the object of the action/activity implemented, for example the URL (“Uniform Resource Locator”) to which the link points. The identifier Id₁=00004 may also be associated with one or more other parameters, such as for example the location of the Web server that stores the resource accessed via the link, the domain name, the reference of the resource accessed via the link, etc.

The identifier Id₁=00005 is associated with at least one parameter or one indicator representative of the object of the action/activity implemented, for example the category of the detected activity, sport, rest, sleeping, etc. The identifier Id₁=00005 may also be associated with one or more other parameters, such as for example the brand of the tracksuit worn by the user UT if the detected activity is a sporting activity, the reference of the book that the user UT is currently reading if the detected activity is rest, etc.

Such a table TAB₁ is stored in a database BD₁ of the geolocation device DGR or made accessible thereto if it does not have the hardware resources and software resources needed to store this database BD₁.

A table TAB₁ is stored for each user UT.

According to one particular embodiment of the disclosure, the actions executed by the geolocation device DGR are implemented by instructions of a computer program PG₁. For this purpose, the device DGR has the conventional architecture of a computer and comprises in particular a memory MEW, a processing unit UTR₁, equipped for example with a processor PROC₁, and driven by the computer program PG₁ stored in memory MEM₁. The computer program PG₁ comprises instructions for performing the actions of determining and storing data DATA_ACTᵣ representative of the action/activity of the user UT in the area ZER, of determining and storing the geolocation data DATA_LOCᵣ of this detected action/activity, of formatting the data DATA_ACTᵣ and DATA_LOCᵣ in the form of the table TAB₁, of storing the table TAB₁ in the database BD₁, as part of the geolocation method that will be described below, when the program is executed by the processor PROC₁, according to any one of the particular embodiments of the disclosure.

On initialization, the code instructions of the computer program PG₁ are for example loaded into a RAM memory (Random Access Memory) (not shown) before being executed by the processor PROC₁. The processor PROC₁ of the processing unit UTR₁ implements in particular the abovementioned actions, according to the instructions of the computer program PG₁.

A description will now be given, with reference to FIG. 2B, of the simplified structure of a geolocation device DGV used in the geolocation system according to an exemplary embodiment of the disclosure, as shown in FIGS. 1B and 1C.

Such a geolocation device DGV comprises:
a communication interface MCO₂ configured to not only communicate with the processing device DET via an appropriate communication network RC, but also to receive, from a device DRV for rendering the virtual environment, the data DATA_ACTᵥ of the abovementioned type, representative of an action/activity of an avatar AV_UT in an area ZEV of the rendered virtual environment,
a memory STO₂ storing the geolocation data DATA_LOCᵥ of the area ZEV in which the avatar AV_UT implements an action/activity, along with the data DATA_ACTᵥ representative of this action.

The geolocation device DGV furthermore comprises a computing device CAL₂ configured to format the data DATA_LOCᵥ and DATA_ACTᵥ in the form of a data association that takes the form for example of the following table TAB₂ for a given avatar AV_UT:

| | | | | Location of the | |
|---|---|---|---|---|---|
| | | | | avatar AV_UT in | Activity |
| | | Type of | Parameter(s) | the area ZEV at | indicator |
| Number of | Timestamp of | action/ | associated with | the time when the | (Ia₂) of |
| the action/ | the action/ | activity | the action/ | action/activity is | the avatar |
| activity | activity | (Id₂) | activity | carried out | AV_UT |
| 1 | 14/01/2022 | 00001 | V457K482TX | (X1ᵥ₁, Y1ᵥ₁, Z1ᵥ₁) | 1 |
| | 17:05:02 | | | | |
| 2 | 14/01/2022 | — | — | — | 0 |
| | 17:15:45 | | | | |
| 3 | 14/01/2022 | 00002 | 65MD4X1652 | (X2ᵥ₁, Y2ᵥ₁, Z2ᵥ₁) | 1 |
| | 17:22:18 | | | | |
| 4 | 14/01/2022 | 00001 | C159H956SH | (X3ᵥ₁, Y3ᵥ₁, Z3ᵥ₁) | 1 |
| | 18:02:36 | | | | |
| 5 | 14/01/2022 | 00004 | 47RG4MF540 | (X4ᵥ₁, Y4ᵥ₁, Z4ᵥ₁) | 1 |
| | 18:34:16 | | | | |
| 6 | . . . | . . . | . . . | . . . | . . . |

In one particular embodiment, the table TAB₂ comprises six columns, namely:
the first column, entitled “Number of the action/activity”, indicates a chronological order number assigned to each action/activity implemented by the avatar AV_UT over time, in a particular area ZEV of the virtual environment,
the second column, entitled “Timestamp of the action/activity”, indicates the date and the time at which a particular action/activity of the avatar AV_UT was detected,
the third column, entitled “Type of action/activity (Id₂)”, indicates the type of action/activity implemented by the avatar AV_UT,
the fourth column, entitled “Parameter(s) associated with the action/activity”, provides information about at least one indicator or one parameter linked to the action/activity implemented by the avatar AV_UT,
the fifth column, entitled “Location of the avatar AV_UT in the area ZEV at the time when the action/activity is carried out”, provides information about the digital coordinates, for example three-dimensional coordinates, of a position of the avatar AV_UT at the time when it implements the action/activity,
the sixth column, entitled “Activity indicator (Ia₂) of the avatar AV_UT”, which is optional, provides information about the activity state or absence of activity of the avatar AV_UT at the time of the detection. In the virtual environment, this indicator is for example:
   set to 0 to indicate that the avatar AV_UT is not active at the time of the detection, either because the avatar AV_UT is not performing a particular action/activity at the time of the detection or because the device DRV for rendering the virtual environment is switched off and is not providing any information to the geolocation device DGV;
   set to 1 as soon as the avatar AV_UT is active at the time of the detection. The type of action/activity “Id₂” uniquely characterizes a particular action or activity. By way of non-exhaustive example:
the identifier Id₂=00001 corresponds to consulting a content item, for example listening to a song, watching a film, etc.,
the identifier Id₂=00002 corresponds to the online purchase of a product, for example shoes, a book, an application, etc.,
the identifier Id₂=00003 corresponds to a search using one or more keywords using a virtual communication terminal, such as the terminal TEV from FIGS. 1B and 1C, etc.,
the identifier Id₂=00004 corresponds to the activation of an Internet link,
the identifier Id₂=00005 corresponds to an activity implemented by the avatar AV_UT, such as for example gardening, boxing, etc.,
etc.

The identifier Id₂=00001 is associated with at least one parameter or one indicator representative of the object of the action/activity implemented, for example a reference V457K482TX or C159H956SH of the consulted content item. The identifier Id₂=00001 may also be associated with a second parameter, such as for example a metadatum characterizing the consulted content item.

The identifier Id₂=00002 is associated with at least one parameter or one indicator representative of the object of the action/activity implemented, for example a reference 65MD4X1652 of the purchased product. The identifier Id₂=00002 may also be associated with one or more other parameters, such as for example keywords characterizing the purchased product, its place of manufacture, the brand of this product, etc.

The identifier Id₂=00003 is associated with at least one parameter or one indicator representative of the object of the action/activity implemented, for example the reference of the website placed first at the end of the search. The identifier Id₂=00003 may also be associated with one or more other parameters, such as for example the keywords of the search, the reference of the Web pages consulted at the end of the search, etc.

The identifier Id₂=00004 is associated with at least one parameter or one indicator representative of the object of the action/activity implemented, for example the URL

(“Uniform Resource Locator”) to which the link points. The identifier Id₂=00004 may also be associated with one or more other parameters, such as for example the location of the Web server that stores the resource accessed via the link, the domain name, the reference of the resource accessed via the link, for example 47RG4MF540, etc.

The identifier Id₂=00005 is associated with at least one parameter or one indicator representative of the object of the action/activity implemented, for example the category of the detected activity, sport, mood, gardening, etc. The identifier Id₂=00005 may also be associated with one or more other parameters, such as for example the colour of the outfit worn by the avatar AV_UT if the detected activity is boxing, the reference of the plants that the avatar AV_UT is tending to if the detected activity is gardening, etc.

Such a table TAB₂ is stored in a database BD₂ of the geolocation device DGV or made accessible thereto if it does not have the hardware resources and software resources needed to store this database BD₂.

A table TAB₂ is stored for each avatar AV_UT.

According to one particular embodiment of the disclosure, the actions executed by the geolocation device DGV are implemented by instructions of a computer program PG₂. For this purpose, the device DGV has the conventional architecture of a computer and comprises in particular a memory MEM₂, a processing unit UTR₂, equipped for example with a processor PROC₂, and driven by the computer program PG₂ stored in memory MEM₂. The computer program PG₂ comprises instructions for performing the actions of determining and storing data DATA_ACTᵥ representative of the action/activity of the avatar AV_UT in the area ZEV, of determining and storing the geolocation data DATA_LOCᵥ of this detected action/activity, of formatting the data DATA_ACTᵥ and DATA_LOCᵥ in the form of the table TAB₂, of storing the table TAB₂ in the database BD₂, as part of the geolocation method that will be described below, when the program is executed by the processor PROC₂, according to any one of the particular embodiments of the disclosure.

On initialization, the code instructions of the computer program PG₂ are for example loaded into a RAM memory (Random Access Memory) (not shown) before being executed by the processor PROC₂. The processor PROC₂ of the processing unit UTR₂ implements in particular the abovementioned actions, according to the instructions of the computer program PG₂.

In the case of the geolocation system shown in FIG. 1C, and in the particular case in which a user UT has N avatars AV_UT₁, AV_UT₂, . . . , AV_UT_{N} in respectively N different virtual environments, the data DATA_LOCᵣ and DATA_ACTᵣ concerning the user UT in the real environment, along with the data DATA_LOCᵥ₁ and DATA_ACTᵥ₁ of his avatar AV_UT₁, the data DATA_LOCᵥ₂ and DATA_ACTᵥ₂ of his avatar AV_UT₂, . . . , the data DATA_LOC_{vN} and DATA_ACT_{vN} of his avatar AV_UT_{N} are formatted jointly in one and the same table TAB₃ as shown below:

| | | | | | Activity |
|---|---|---|---|---|---|
| | | Type of | Parameter(s) | Location of the | indicator |
| Number of | Timestamp of | action/ | associated with | user UT and | (Ia) of the |
| the action/ | the action/ | activity | the action/ | avatar(s) of | avatars of |
| activity | activity | (Id) | activity | the user UT | the user UT |
| 1 | 17/03/2022 | 00001 | V457K482TX | (X1ᵣ, Y1ᵣ, Z1ᵣ) | 1 |
| | 09:13:56 | . . . | 64KD4FD137 | (X1ᵥ₁, Y1ᵥ₁, Z1ᵥ₁) | 0 |
| | | 00004 | | (X1ᵥ₂, Y1ᵥ₂, Z1ᵥ₂) | 0 |
| | | | | . . . | . . . |
| | | | | (X1_{vN}, Y1_{vN}, Z1_{vN}) | 1 |
| 2 | 17/03/2022 | 00002 | 65GJ1H365P | (X2ᵣ, Y2ᵣ, Z2ᵣ) | 1 |
| | 09:28:04 | | | (X2ᵥ₁, Y2ᵥ₁, Z2ᵥ₁) | 0 |
| | | | | (X2ᵥ₂, Y2ᵥ₂, Z2ᵥ₂) | 0 |
| | | | | . . . | . . . |
| | | | | (X2_{vN}, Y2_{vN}, Z2_{vN}) | 0 |
| 3 | . . . | . . . | . . . | . . . | . . . |

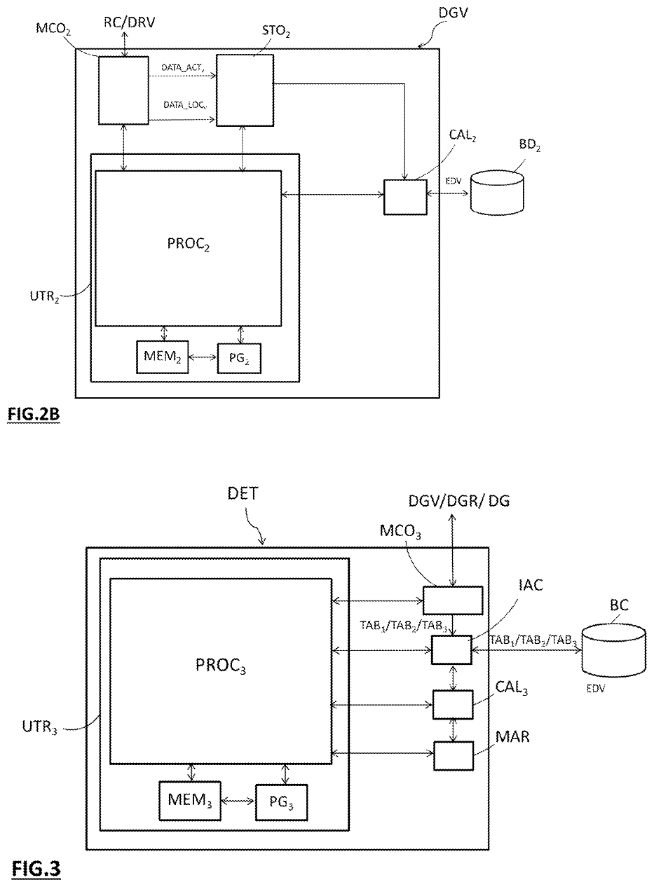

A description will now be given, with reference to FIG. 3, of the simplified structure of a device DET for processing geolocation data, which device is used in the geolocation system according to an exemplary embodiment of the disclosure, as shown in FIGS. 1A to 1C.

Such a device DET comprises:
a communication interface MCO₃ configured to receive, from the geolocation device DGR or DGV, the tables TAB₁ and TAB₂, respectively, or else, from a geolocation device DG grouping together the two geolocation devices DGR or DGV, the table TAB₃,
an access interface IAC to a knowledge base BC that is configured to inject the information contained in the tables TAB₁, TAB₂ and/or TAB₃ into said knowledge base,
a computing device CAL₃ that is configured to determine, depending on the implementation context of the geolocation system:
   whether the actions/activities corresponding to the identifiers of the table TAB₁ or TAB₃ have already been implemented predominantly, significantly or frequently by a plurality of users (physical people) in the area ZER under consideration, and/or
   whether the actions/activities corresponding to the identifiers of the table TAB₂ or TAB₃ have already been implemented predominantly, significantly or frequently by a plurality of user avatars in the area ZEV under consideration,
a marking device MAR that is configured, in the event of positive determination by the computing device CAL₃, to:
   tag/mark the area ZER under consideration as an area of the real environment dedicated to the provision of at least one element linked to the data DATA_ACTᵣ associated with the area ZER or as an area of the real environment able to be configured on the basis of the data DATA_ACTᵣ,
   tag/mark the area ZEV as an area of the virtual environment dedicated to the provision of at least one element linked to the data DATA_ACTᵥ or DATA_ACTᵥ₁, DATA_ACTᵥ₂, DATA_ACT_{vN} respectively associated with the areas ZEV, ZEV₁, ZEV₂, . . . , ZEV_{N}, or as an area of the virtual environment able to be configured on the basis of the data DATA_ACTᵥ or DATA_ACTᵥ₁, DATA_ACTᵥ₂, DATA_ACT_{vN}. The actions already implemented by the plurality of users, to which the user UT may belong, respectively by the plurality of user avatars, to which the avatar AV_UT may belong, are contained in the knowledge base BC, which is either contained in the processing device DET if it has sufficient hardware resources and software resources, or made accessible to the processing device DET.

By way of non-exhaustive example, the processing device DET may be a neural network, be based on deep learning technology, be based on statistical learning technology, etc.

According to one particular embodiment of the disclosure, the actions executed by the processing device DET are implemented by instructions of a computer program PG₃. For this purpose, the device DET has the conventional architecture of a computer and comprises in particular a memory MEM₃, a processing unit UTR₃, equipped for example with a processor PROC₃, and driven by the computer program PG₃ stored in memory MEM₃. The computer program PG₃ comprises instructions for performing the actions of receiving the tables TAB₁, TAB₂ and/or TABS, of injecting the information from these one or more tables into the knowledge base BC, of determining the relevance of the areas ZER or ZEV, ZEV₁, ZEV₂, . . . , ZEV_{N}, of tagging/marking the areas ZER or ZEV, ZEV₁, ZEV₂, ZEV_{N}, as part of the geolocation method that will be described below, when the program is executed by the processor PROC₃, according to any one of the particular embodiments of the disclosure.

On initialization, the code instructions of the computer program PG₃ are for example loaded into a RAM memory (Random Access Memory) (not shown) before being executed by the processor PROC₃. The processor PROC₃ of the processing unit UTR₃ implements in particular the abovementioned actions, according to the instructions of the computer program PG₃.

A description will now be given, with reference to FIGS. 4A, 1A, 1C, 2A and 3, of the sequence of a geolocation method according to a first particular embodiment of the disclosure.

In this first embodiment, the geolocation method is implemented by the geolocation system shown in FIGS. 1A and 1C.

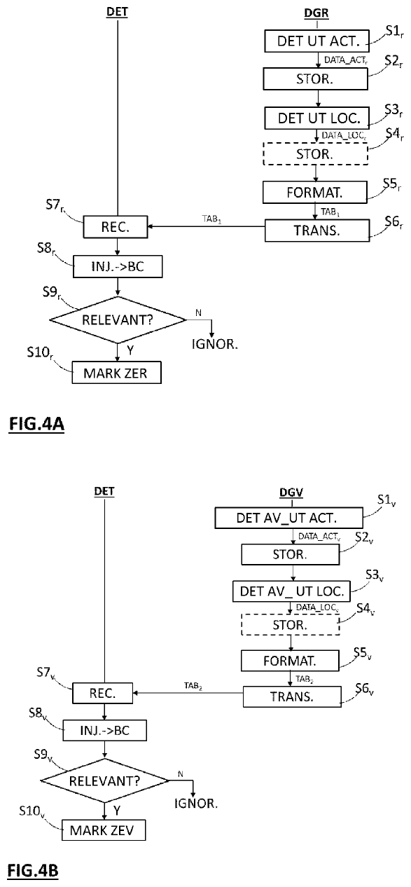

The geolocation method of FIG. 4A is implemented for a given user UT, for a given duration, for example a given day, a given week, a given semester, etc.

In a step S1ᵣ, the geolocation device DGR (FIGS. 1A and 1C) detects that the user UT is implementing an action/activity in an area ZER of the real environment in which the user UT moves.

To this end, the device DGR receives, via its communication interface MCO₁, the data DATA_ACTᵣ from the smartphone TEL, from the multimedia terminal BOR, from the connected object OBC, from the augmented-reality interface IRA, from the sensor CAP, from the drone DRO, etc.

At S2ᵣ, the data DATA_ACTᵣ are stored in the memory STO₁.

In a step S3ᵣ, the device DGR determines geolocation data of the area ZER in which the user UT has implemented an action/activity. To this end, in step S3ᵣ, the device DGR accesses, in the memory STO₁, its own geolocation data DATA_LOCᵣ₀ if the device DGR is located in the area ZER. In this context, step S3r may also comprise receiving, via the communication interface MCO₁, geolocation data DATA_LOCᵣ from the smartphone TEL, from the multimedia terminal BOR, from the connected object OBC, from the augmented-reality interface IRA, from the sensor CAP, from the drone DRO, etc. If the device DGR is not located in the area ZER, step S3ᵣ is limited to receiving, via the communication interface MCO₁, geolocation data DATA_LOCᵣ from the smartphone TEL, from the multimedia terminal BOR, from the connected object OBC, from the augmented-reality interface IRA, from the sensor CAP, from the drone DRO, etc.

At S4ᵣ, the data DATA_LOCᵣ are stored if necessary in the memory STO₁.

Steps S1ᵣ and S3ᵣ, respectively S2ᵣ and S4ᵣ, may be implemented simultaneously or successively in any order.

At S5ᵣ, the geolocation device DGR, via its computing device CAL₁, formats an association EDR between the data DATA_LOCᵣ and DATA ACTT in the abovementioned table TAB₁. To this end, these data are injected into the abovementioned table TAB₁, which has been stored beforehand in the database BD₁. At S6ᵣ, the geolocation device DGR transmits the table TAB₁ to the processing device DET, via its communication interface MCO₁ if the geolocation device DGR is remote from the processing device DET, or via an internal link, for example a data bus, if the geolocation device DGR and the processing device DET form part of the same entity. Steps S1ᵣ to S6ᵣ are iterated at various predefined times of the given duration. The geolocation method that has just been described is then implemented for a set of users.

In a step S7ᵣ, the processing device DET receives, via its communication interface MCO₃, the table TAB₁.

At S8ᵣ, the processing device DET, via its access interface IAC, injects the data contained in the table TAB₁ into the knowledge base BC.

In a step S9ᵣ, the computing module CAL₃ of the processing device DET then explores the knowledge base BC to determine whether the actions/activities corresponding to the identifiers/parameters of the table TAB₁ have already been implemented predominantly, significantly or frequently by a plurality of users (physical people) in the area ZER under consideration.

If so (“Y” in FIG. 4A), the marking device MAR of the processing device DET identifies, at S10ᵣ, the area ZER under consideration at a given time as an area of the real environment dedicated to the provision of at least one element linked to the data DATA_ACTᵣ associated with the area ZER or as an area of the real environment able to be configured on the basis of the data DATA_ACTᵣ. To this end, the marking device MAR tags the area ZER in the knowledge base BC.

If not (“N” in FIG. 4A), the actions/activities corresponding to the identifiers/parameters of the table TAB₁ are ignored.

A description will now be given, with reference to FIGS. 4B, 1B, 1C, 2B and 3, of the sequence of a geolocation method according to a second particular embodiment of the disclosure.

In this second embodiment, the geolocation method is implemented by the geolocation system shown in FIGS. 1B and 1C.

The geolocation method of FIG. 4B is implemented for a given avatar AV_UT of a user, for a given duration, for example a given day, a given week, a given semester, etc.

In a step S1ᵥ, the geolocation device DGV (FIGS. 1B and 1C) detects that the avatar AV_UT is implementing an action/activity in an area ZEV of the virtual environment in which the avatar AV_UT moves.

To this end, the device DGV receives, from the device DRV for rendering the virtual environment containing the area ZEV, via its communication interface MCO₂, the data DATA_ACTᵥ of the abovementioned type, representative of an action/activity of the avatar AV_UT in the area ZEV.

At S2ᵥ, the data DATA_ACTᵥ are stored in the memory STO₂.

In a step S3ᵥ, the device DGV determines geolocation data DATA_LOCᵥ of the area ZEV in which the avatar AV_UT has implemented an action/activity. To this end, in step S3ᵥ, the device DGV receives, from the device DRV for rendering the virtual environment containing the area ZEV, via its communication interface MCO₂, the data DATA_LOCᵥ of the abovementioned type.

At S4ᵥ, the data DATA_LOCᵥ are stored in the memory STO₂.

Steps S1ᵥ and S3ᵥ, respectively S2ᵥ and S4ᵥ, may be implemented simultaneously or successively in any order.

At S5ᵥ, the geolocation device DGV, via its computing device CAL₂, formats an association EDV between the data DATA_LOCᵥ and DATA_ACTᵥ in the abovementioned table TAB₂. To this end, these data are injected into the abovementioned table TAB₂, which has been stored beforehand in the database BD₂. At S6ᵥ, the geolocation device DGV transmits the table TAB₂ to the processing device DET, via its communication interface MCO₂ if the geolocation device DGV is remote from the processing device DET, or via an internal link, for example a data bus, if the geolocation device DGV and the processing device DET form part of the same entity.

Steps S1ᵥ to S6ᵥ are iterated at various predefined times of the given duration.

The geolocation method that has just been described is then implemented for a set of user avatars.

In a step S7ᵥ, the processing device DET receives, via its communication interface MCO₃, the table TAB₂.

At S8ᵥ, the processing device DET, via its access interface IAC, injects the data contained in the table TAB₂ into the knowledge base BC.

In a step S9ᵥ, the computing module CAL₃ of the processing device DET then explores the knowledge base BC to determine whether the actions/activities corresponding to the identifiers/parameters of the table TAB₂ have already been implemented predominantly, significantly or frequently by a plurality of user avatars in the area ZEV under consideration.

If so (“Y” in FIG. 4B), the marking device MAR of the processing device DET identifies, at S10ᵥ, the area ZEV under consideration at a given time as an area of the virtual environment dedicated to the provision of at least one element linked to the data DATA_ACTᵥ associated with the area ZEV or as an area of the virtual environment able to be configured on the basis of the data DATA_ACTᵥ. To this end, the marking device MAR tags the area ZEV in the knowledge base BC.

If not (“N” in FIG. 4B), the actions/activities corresponding to the identifiers/parameters of the table TAB₂ are ignored.

A description will now be given, with reference to FIGS. 4C, 1C, 2A to 3, of the sequence of a geolocation method according to a third particular embodiment of the disclosure.

In this third embodiment, the geolocation method is implemented by the geolocation system shown in FIG. 1C.

The geolocation method of FIG. 4C is implemented at a given time of the geolocation duration that has been predefined, for a given user UT, and also a plurality of avatars AV_UT₁, AV_UT₂, AV_UT_{N} associated with this user UT in respectively N virtual environments EV₁, EV₂, . . . , EV_{N}.

In a step S1ᵣᵥ, at a given time t, the geolocation device DG (FIG. 1C) detects that the user UT is implementing an action/activity in an area ZER of the real environment in which the user UT moves.

In this step S1ᵣᵥ, the geolocation device DG then implements detection of the active or inactive nature of the avatars AV_UT₁, AV_UT₂, AV_UT_{N} in a respective virtual area ZEV₁, ZEV₂, ZEV_{N} of their corresponding virtual environments EV₁, EV₂, . . . , EV_{N}.

To this end, the device DG receives:
via its communication interface MCO₁, the data DATA_ACTᵣ from the smartphone TEL, from the multimedia terminal BOR, from the connected object OBC, from the augmented-reality interface IRA, from the sensor CAP, from the drone DRO, etc.,
via its communication interface MCO₂, from all or some of N devices for rendering respectively N virtual environments each containing a respective virtual area ZEV₁, ZEV₂, . . . , ZEV_{N} depending on the active or inactive nature of the avatars AV_UT₁, AV_UT₂, . . . , AV_UT_{N}, all or some of the data DATA_ACTᵥ₁, DATA_ACTᵥ₂, . . . , DATA_ACT_{vN} of the abovementioned type, representative of an action/activity of the corresponding avatars AV_UT₁, AV_UT₂, . . . , AV_UT_{N} in each of their areas ZEV₁, ZEV₂, ZEV_{N}.

At S2ᵣᵥ, the data DATA_ACTᵣ are stored in the memory STO₁, whereas the data DATA_ACTᵥ₁ to DATA_ACT_{vN} are stored in the memory STO₂. As an alternative, the geolocation device DG could store all of these data in a single memory.

In a step S3ᵣᵥ, the device DG determines geolocation data of the area ZER in which the user UT has implemented an action/activity. This step is identical to the abovementioned step S3ᵣ and, for this reason, will not be described again.

In this step S3ᵣᵥ, the device DG also determines, based on the active or inactive nature of the avatars AV_UT₁, AV_UT₂, . . . , AV_UT_{N} of the user UT, all or some of the geolocation data DATA_LOCᵥ₁, DATA_LOCᵥ₂, . . . , DATA_LOC_{vN} relating respectively to the areas ZEV₁, ZEV₂, . . . , ZEV_{N} in which the corresponding avatars AV_UT₁, AV_UT₂, . . . , AV_UT_{N} have implemented an action/activity. To this end, in step S3ᵣᵥ, the device DG receives, from each device DR₁ to DR_{N} for respectively rendering each virtual environment EV₁ to EV_{N}, via its communication interface MCO₂, all or some of the geolocation data DATA_LOCᵥ₁, DATA_LOCᵥ₂, . . . , DATA_LOC_{vN}.

At S4ᵣᵥ:
the data DATA_LOCᵣ are stored if necessary in the memory STO₁,
the geolocation data available from among the data DATA_LOCᵥ₁, DATA_LOCᵥ2, . . . , DATA_LOC_{vN} are stored if necessary in the memory STO₂.

As an alternative, the geolocation device DG could store all of these data in a single memory.

Steps S1ᵣᵥ and S3ᵣᵥ, respectively S2ᵣᵥ and S4ᵣᵥ, may be implemented simultaneously or successively in any order.

At S5ᵣᵥ, the geolocation device DG, via its computing device CAL₁, formats an association EDR between the data DATA_LOCᵣ and DATA_ACTᵣ in the abovementioned table TAB₃. To this end, these data are injected into the abovementioned table TAB₃, which has been stored beforehand in the database BD₁. In step S5ᵣᵥ, the geolocation device DG, via its computing device CAL₂, formats, in the abovementioned table TAB₃:
an association EDV₁ between the data DATA_LOCᵥ₁ and DATA_ACTᵥ₁ if these data are available. To this end, these data are injected into the abovementioned table TAB₃, which has been stored beforehand in the database BD₂,
an association EDV₂ between the data DATA_LOCᵥ₂ and DATA_ACTᵥ₂ if these data are available. To this end, these data are injected into the abovementioned table TAB₃, which has been stored beforehand in the database BD₂,
. . . ,
an association EDV_{N} between the data DATA_LOC_{vN} and DATA_ACT_{vN} if these data are available. To this end, these data are injected into the abovementioned table TAB₃, which has been stored beforehand in the database BD₂.

As an alternative, step S5ᵣᵥ may be implemented using a single computing device and a single database.

At S6ᵣᵥ, the geolocation device DG transmits the table TAB₃ to the processing device DET, via its communication interface MCO₁ or MCO₂ or possibly a single communication interface, if the geolocation device DG is remote from the processing device DET, or via an internal link, for example a data bus, if the geolocation device DG and the processing device DET form part of the same entity.

Steps S1ᵣᵥ to S6ᵣᵥ are iterated at various predefined times of the given duration. The geolocation method that has just been described is then implemented for a set of users and their corresponding avatars.

In a step S7ᵣᵥ, the processing device DET receives, via its communication interface MCO₃, the table TAB₃.

At S8ᵣᵥ, the processing device DET, via its access interface IAC, injects the data contained in the table TAB₃ into the knowledge base BC.

In a step S9ᵣᵥ, the computing module CAL₃ of the processing device DET then explores the knowledge base BC to determine whether the actions/activities corresponding to the identifiers/parameters of the table TAB₃ have already been implemented predominantly, significantly or frequently by a plurality of users (physical people) in the area ZER under consideration, respectively by a plurality of user avatars in all or some of the areas ZEV₁, ZEV₂, . . . , ZEV_{N}, depending on whether or not they have been considered on the basis respectively of the activity or the absence of activity of the corresponding avatars AV_UT₁, AV_UT₂, . . . , AV_UT_{N} in each of these areas.

If so (“Y” in FIG. 4C), the marking device MAR of the processing device DET identifies, at S10ᵣᵥ:
the area ZER under consideration at a given time as an area of the real environment dedicated to the provision of at least one element linked to the data DATA_ACTᵣ associated with the area ZER or as an area of the real environment able to be configured on the basis of the data DATA_ACTᵣ,
the one or more areas ZEV₁, ZEV₂, . . . , ZEV_{N} under consideration at a given time as virtual areas each dedicated to the provision of at least one element linked to the data DATA_ACTᵥ₁, DATA_ACTᵥ₂, . . . , DATA_ACT_{vN} respectively associated with the areas ZEV₁, ZEV₂, . . . , ZEV_{N} or as virtual areas able to be configured on the basis respectively of the data DATA_ACTᵥ₁, DATA_ACTᵥ₂, . . . , DATA_ACT_{vN}.

To this end, the marking device MAR tags the area ZER, along with the one or more areas ZEV₁, ZEV₂, . . . , ZEV_{N}, in the knowledge base BC.

If not (“N” in FIG. 4C), the actions/activities corresponding to the identifiers/parameters of the table TAB₃ are ignored.

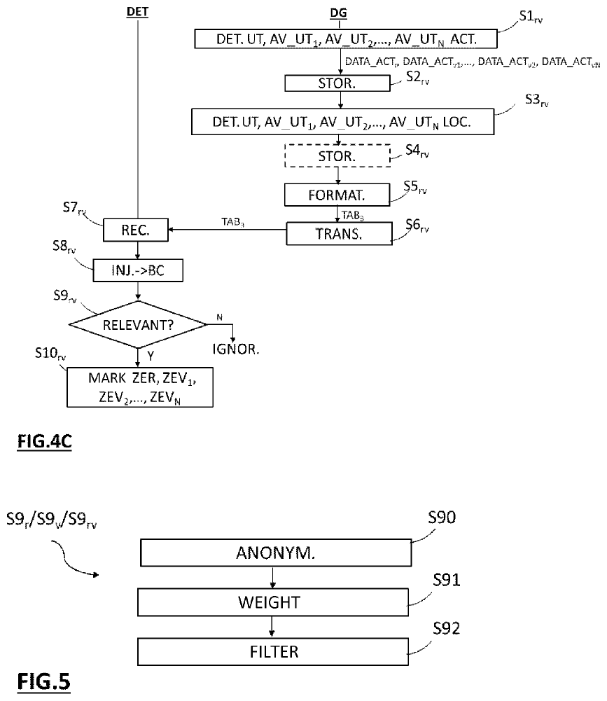

A description is now given, with reference to FIG. 5, of various actions implemented by the device DET for processing geolocation data when it explores the tables TAB₁, TAB₂ and TAB₃.

In one or the other of the abovementioned steps S9ᵣ, S9ᵥ, S9ᵣᵥ, the device DET implements the following:

At S90, the device DET anonymizes the data contained in the tables TAB₁, TAB₂ and TAB₃.

At S91, the device DET assigns different weights to each type of action identified in the tables TAB₁, TAB₂ and TAB₃. By way of non-exhaustive example, the purchase of a given product by a user or an avatar may have a relatively high weight, while a simple search for information about this same product may have a lower weight.

At S92, the device DET filters the data contained in the tables TAB₁, TAB₂ and TAB₃. By way of non-exhaustive example, the device DET may set a threshold of a certain number of keywords associated with a particular action/activity, for example when searching for a brand or purchasing a product detected in an area, and if this number is not reached, not take the detected action/activity into account. According to another example, in the case of exploring the table TAB₃, if it is determined that the actions of a particular avatar are never or virtually never implemented by other avatars in the same virtual area, the actions of this particular avatar will no longer be explored thereafter by the device DET.

The information linked to the marking carried out in steps S10ᵣ, S10ᵥ, S10ᵣᵥ is particularly relevant information that may be used, by way of non-exhaustive example:
to supply advertising locations, virtual points of sale, etc. that are to be installed or that are already installed in the areas ZER and/or ZEV and/or ZEV₁, ZEV₂, . . . , ZEV_{N}, with one or more content items, one or more products and/or one or more services having a common point with the particular actions/activities detected in these areas;
to provide:
   in the area ZER, an augmented-reality digital content item that is relevant with respect to the action/activity detected in the area ZER;
   in the areas ZEV and/or ZEV₁, ZEV₂, . . . , ZEV_{N}, a virtual-reality digital content item that is relevant with respect to the action/activity detected in these areas,
to allow advertising departments to implement targeted advertising or product marketing in the areas ZER and/or ZEV and/or ZEV₁ and/or ZEV₂, . . . , and/or ZEV_{N},
to allow territorial communities, provisional town-planning agencies, video game publishers, etc. for example to apprehend, with greater precision and reliability, a real or virtual area that has received a marking, in order to rearrange/modify this real or virtual area with a view to adapting it to the needs of users or avatars in this area. One or more exemplary embodiments of the application overcome drawbacks of the abovementioned prior art by proposing a geolocation method that has the ability to use the geolocation data of a user in a much richer and finer manner than those that are used in conventional geolocation methods.

It goes without saying that the embodiments described above have been given purely by way of completely non-limiting indication, and that numerous modifications may be easily made by a person skilled in the art without otherwise departing from the scope of the disclosure and/or the appended claims.

1. A geolocation method implemented by at least one device and comprising:
detecting that a user or an avatar of a user is carrying out an action in the user's or avatar's respectively real or virtual environment;
determining geolocation data of an area of the real or virtual environment in which the action was detected; and
based on said geolocation data and data representative of the detected action:
determining that the action corresponding to the geolocation data has already been implemented by a plurality of physical people in said area of the real environment or by a plurality of avatars in said area of the virtual environment, and that the implementation of said action is predominant with respect to the implementation of at least one other action in said area of the real or virtual environment; and
identifying said area as an area of the real or virtual environment dedicated to provision of at least one element linked to the data representative of the detected action or as an area of the real or virtual environment able to be configured on the basis of said data representative of the detected action.

2. The geolocation method according to claim 1, wherein:
said action carried out in the real environment comprises an interaction of the user with an interface present in the real environment or an activity of the user that has been detected autonomously by an activity detection appliance,
said action carried out in the virtual environment comprises an interaction of the avatar of a user with an object or another avatar in the virtual environment.

3. The geolocation method according to claim 1, wherein said element provided in the identified area is a multimedia content item.

4. The geolocation method according to claim 1, wherein the method comprises, in response to the area of the real or virtual environment being identified as a configurable area, modifying said area so as to provide a product or a service, linked to the detected action, to a user who is located in said identified area of the real environment or to an avatar of a user that is located in said identified area of the virtual environment.

5. The geolocation method according to claim 1, wherein, for the particular user, at a given time, the geolocation method is implemented simultaneously in the real environment where the user is moving and/or in at least one virtual environment where the avatar of said user is moving.

6. The geolocation method according to claim 1, wherein the geolocation data of the area of said at least one virtual environment that are determined when implementing said geolocation method are associated with an activity indicator of the avatar of the user in this area, said indicator being set to a first value representative of an absence of activity of the avatar or to a second value representative of actual activity of the avatar.

7. The geolocation method according to claim 1, wherein the geolocation data of said area comprise:
two-dimensional, respectively three-dimensional, coordinates of a point of said area, and
a radius of a circle, respectively of a sphere, centred on said point.

8. The geolocation method according to claim 1, wherein the data representative of the detected action comprise at least one identifier representative of a type of action.

9. The geolocation method according to claim 8, wherein the identifier representative of the type of action is associated with at least one indicator of an object targeted by the action.

10. The geolocation method according to claim 8, wherein the identifier representative of the type of action is associated with a weighting value of the action.

11. A geolocation device, comprising:
a processor that is configured to implement:
detecting that a user or an avatar of a user is carrying out an action in the user's or avatar's respectively real or virtual environment;
determining geolocation data of an area of the real or virtual environment in which the action was detected; and
transmitting said geolocation data and data representative of the detected action to a data processing device.

12. A device for processing geolocation data, comprising:
a processor that is configured to implement:
receiving, from a geolocation device, geolocation data of an area of a real or virtual environment in which an action carried out by a user or an avatar of a user, in the user's or avatar's real or virtual environment, respectively, has been detected, and data representative of the detected action; and
in response to determining that the action corresponding to the received data has already been implemented by a plurality of physical people in said area of the real environment, respectively by a plurality of avatars in said area of the virtual environment, and that the implementation of said action is predominant with respect to the implementation of at least one other action in said area, identifying said area as an area dedicated to provision of at least one element linked to the data representative of the detected action or as an area able to be configured on the basis of said data representative of the detected action.

13. A geolocation system comprising:
a geolocation device comprising a first processor that is configured to implement:
detecting that a user or an avatar of a user is carrying out an action in the user's or avatar's respectively real or virtual environment;
determining geolocation data of an area of the real or virtual environment in which the action was detected; and
transmitting said geolocation data and data representative of the detected action to a data processing device; and
the data processing device, which comprises a second processor that is configured to implement:
receiving, from the geolocation device, the geolocation data and the data representative of the detected action; and
in response to determining that the action corresponding to the received data has already been implemented by a plurality of physical people in said area of the real environment, respectively by a plurality of avatars in said area of the virtual environment, and that the implementation of said action is predominant with respect to the implementation of at least one other action in said area, identifying said area as an area dedicated to provision of at least one element linked to the data representative of the detected action or as an area able to be configured on the basis of said data representative of the detected action.

14. At least one computer-readable information medium comprising instructions of a computer program stored thereon which when executed by at least one processor configure the at least one processor to implement a method comprising:
detecting that a user or an avatar of a user is carrying out an action in the user's or avatar's respectively real or virtual environment;
determining geolocation data of an area of the real or virtual environment in which the action was detected; and
based on said geolocation data and data representative of the detected action:
determining that the action corresponding to the geolocation data has already been implemented by a plurality of physical people in said area of the real environment or by a plurality of avatars in said area of the virtual environment, and that the implementation of said action is predominant with respect to the implementation of at least one other action in said area of the real or virtual environment; and
identifying said area as an area of the real or virtual environment dedicated to provision of at least one element linked to the data representative of the detected action or as an area of the real or virtual environment able to be configured on the basis of said data representative of the detected action.
